(19) United States
(12) Patent Application Publication
(10) Pub. No.: US 2008/0068249 A1
(43) Pub. Date: Mar. 20, 2008

(54) Radar apparatus

(75) Inventors: Yutaka Yaginuma, Kawasaki (JP); Hiroshi Ogura, Kawasaki (JP); Yutaka Moriyama, Kawasaki (JP); Toshiaki Usui, Kawasaki (JP); Masaaki Mikuni, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/905,139

(22) Filed: Sep. 27, 2007

Related U.S. Application Data
(63) Continuation of application No. PCT/JP2005/006086, filed on Mar. 30, 2005.

(51) Int. Cl. G01S 7/03; G01S 13/00; H01Q 15/14

(52) U.S. Cl. 342/1; 342/175

(57) ABSTRACT

A housing has an electric opening in a position corresponding to the radar. A shielding plate is provided between the radar and the electric opening and has an opening including a plurality of unit openings in a position corresponding to the radar. The unit openings satisfy a relation (half-wave length of radio wave that should be shielded)>(maximum dimension “r” of the unit openings)>(half-wave length of radio wave transmitted by the radar). An opening ratio “s” is set to satisfy a relation ((power amount of the transmission wave of the radar)−(attenuated power amount of the transmission wave of the radar))>(the threshold of the radar)>(power amount of the reflected wave at the shielding plate).

### CROSS REFERENCE TO RELATED APPLICATIONS

This is a continuation application of PCT application serial number PCT/JP2005/006086, filed on Mar. 30, 2005.

### BACKGROUND OF THE INVENTION

1. Field of the Invention

This invention relates to a radar apparatus, and more particularly to a radar apparatus which is used for, for example, an obstacle sensor to detect obstacles using millimeter wave and in which radiation of unnecessary radio wave is reduced and EMI is reduced.

2. Description of the Related Art

A radar apparatus that transmits and receives millimeter wave may be used as an object (obstacle) sensor (Japanese Patent Laid-Open No. 2004-136785). In this case, as radio wave (electromagnetic wave) transmitted and received, for example, radio wave at a frequency of 76 GHz are used (which is allocated by the law).

Such a radar apparatus (object sensor) includes a radar that transmits and receives the radio wave (the millimeter wave), a signal processing circuit board, and a housing in which the radar and the signal processing circuit board are housed (or stored). An opening (an electric opening) is provided on the housing in order to transmit and receive the radio wave. The electric opening is provided in front of the radar, and formed in a size equal to or larger than an area of the radar not to interfere with the transmission and reception of the radio wave. In order to block the inside of the housing from the outside air, the electric opening is covered with a radome (radar dome) that is transparent to the radio wave, or capable of transmitting the radio wave in a range of an allowable attenuation amount.

Concerning an electronic apparatus, in general, unnecessary radio wave radiated from the electronic apparatus to the outside are legally regulated for reduction of EMI (Electro Magnetic Interference). These regulations are different depending on countries and regions, and various regulations are present. On the other hand, the radar apparatus used as the object sensor essentially has the electric opening as described above. Therefore, there is a possibility that radio wave generated by the signal processing circuit in the housing are radiated from the electric opening to the outside of the apparatus as unnecessary radio wave.

For example, the VCCI (Voluntary Control Council for Information Technology Equipment), which is one of the regulations in Japan, regulates radiation of radio waves at 30 KHz to 1 GHz. In this case, a minimum half-wave length of the radio wave above regulated by the VCCI is λ/2=150 mm. On the other hand, in the radar apparatus used as the object sensor, usually, a maximum dimension of the electric opening (for example, in the case that the electric opening is a rectangular, the length of a diagonal) is smaller than 15 cm. Therefore, it can be said that radio wave generated from the signal processing circuit are not generally radiated to the outside. Thus, it is unnecessary to take any special measures against the radio wave.

However, the FCC (Federal Communications Commission), which is one of the regulations in the United States, regulates radiation of a fifth harmonics at an (internal) operation frequency of the signal processing circuit and radio wave in a high-frequency band such as 40 GHz or less. In this case, a half-wave length of radio wave above regulated by the FCC is sufficiently shorter than the maximum dimension of the electric opening. Therefore, since radio wave generated from the signal processing circuit are radiated to the outside, it is necessary to shield (or attenuate) radio wave radiated from the signal processing circuit board.

### SUMMARY OF THE INVENTION

It is an object of the present invention to provide a radar apparatus in which radiation of unnecessary radio wave from an electric opening is reduced and EMI is reduced without affecting transmission and reception of original radio wave.

A radar apparatus of the present invention includes a radar transmitting and receiving radio wave of a predetermined frequency, a signal processing circuit board mounted with a signal processing circuit which controls the transmission and reception of the radio wave by the radar and performs detection processing of the radio wave received by the radar using a predetermined threshold, a housing having an electric opening in a position corresponding to the radar, and being provided with the radar and the signal processing circuit board inside of the housing in a state that the radar is opposed to the electric opening, and a shielding plate made of a planar conductive material, provided between the radar and the electric opening of the housing, and having an opening which includes a plurality of unit openings in a position corresponding to the radar. The unit openings satisfy a relation (half-wave length of radio wave which should be shielded)>(maximum dimension of the unit openings)>(half-wave length of radio wave transmitted by the radar). An opening ratio of the opening is set to satisfy a relation ((power amount of the transmission wave of the radar)−(attenuated power amount of transmission wave of the radar))>(the threshold of the radar)>(power amount of reflected wave at the shielding plate). In this case, preferably, the radio wave which should be shielded is high-order harmonics at an operation frequency of the signal processing circuit.

Preferably, in the radar apparatus of the present invention, the shielding plate is provided in a position which is apart from the radar by a predetermined distance, and is formed in parallel to the radar.

Preferably, in the radar apparatus of the present invention, the shielding plate is provided in a position which is apart from the radar by a predetermined distance, and is formed so as to incline by a predetermined angle with respect to the radar.

Preferably, in the radar apparatus of the present invention, the shielding plate is provided to satisfy a relation (the threshold of the radar)>Ps×s(1-y sin 2θ/h), where an opening ratio of the opening is s, power amount of the transmission wave is Ps, a distance between the radar and the shielding plate is y, an inclination of the shielding plate with respect to the radar is θ, and width of the radar is h.

Preferably, in the radar apparatus of the present invention, the shielding plate is provided to satisfy a relation s²Ps>(the threshold of the radar)>Ps×s(1-y sin 2θ/h).

Preferably, in the radar apparatus of the present invention, a maximum dimension of the unit openings of the opening of the shielding plate is a maximum dimension of projected images of the unit openings in the case that the unit openings are projected on a plane parallel to the radar. In this case, preferably, an opening ratio of the opening of the shielding plate is an opening ratio of a projected image of the opening in the case that the opening is projected on a plane parallel to the radar.

Preferably, in the radar apparatus of the present invention, the shielding plate is provided in a position which is apart from the radar by a predetermined distance, and is bent to be line symmetrical in the center thereof. In this case., preferably, when compared with a case that the shielding plate is provided in a first position apart from the radar to be inclined by a first angle with respect to the radar without being bent, the bent shielding plate is provided in a second position closer to the radar than the first position at the first angle.

Preferably, the radar apparatus of the present invention further includes a radio wave absorbent provided at least at the opening in a surface of the shielding plate, and the surface is opposed to the radar. In this case, preferably, the radio wave absorbent absorbs radio wave transmitted from the radar and reflected by the shielding plate.

Preferably, the radar apparatus of the present invention further includes a material layer provided at least at the opening in a surface of the shielding plate, and causing a path difference in radio wave reflected on the shielding plate, the surface being opposed to the radar. In this case, preferably, the material layer causing the path difference is set to thickness ¼ of a wavelength of radio wave transmitted from the radar.

Preferably, in the radar apparatus of the present invention, cut pieces formed by punching out the shielding plate to form the plurality of unit openings in the shielding plate are bent to a side of a surface of the shielding plate without being cut off from the shielding plate, and the surface is opposed to the radar. In this case, preferably, the cut pieces are bend to reflect radio wave reflected on the shielding plate in a direction away from the radar.

In the radar apparatus of the present invention, the shielding plate is provided between the radar and the electric opening. The opening of this shielding plate includes the unit openings satisfying the relation (half-wave length of radio wave that should be shielded)>(maximum dimension of the unit openings)>(half-wave length of radio wave transmitted by the radar), and has an opening ratio satisfying the relation ((power amount of transmission wave of the radar)−(attenuated power amount of transmission wave of the radar))>(the threshold of the radar)>(power amount of reflected wave at the shielding plate).

Therefore, the radio wave that should be shielded is larger than a maximum dimension of the unit openings, so that the radio wave to be shielded cannot be transmitted through the unit openings. Consequently, it is possible to shield (or attenuate) radio wave radiated from the signal processing circuit, and prevent the radio wave from being radiated to the outside. On the other hand, radio wave transmitted by the radar is smaller than the maximum dimension of the unit openings, so that the radio wave can be transmitted through the unit openings. Consequently, even if the shielding plate is provided, it is possible to prevent the shielding plate from interfering with transmission and reception of original radio wave.

A difference between the power amount of the transmission wave of the radar and an attenuated power amount of the transmission wave of the radar is larger than a threshold of the radar, and smaller than a threshold of the radar at the shielding plate. Thus, even if there is attenuation due to the shielding plate, it is possible to detect received radio wave. Consequently, even if the shielding plate is provided, it is possible to receive radio wave reflected on an object (an obstacle), and detect the object.

As described above, according to the present invention, in the radar apparatus essentially having the electric opening, it is possible to prevent radio wave generated from the signal processing circuit from being radiated from the electric opening to the outside of the apparatus as unnecessary radio wave, and it is possible to minimize an influence on transmission and reception of original radio wave of the radar apparatus as much as possible. For example, when radio wave that should be shielded are high-order (e.g., fifth) harmonics at an operation frequency of the signal reception circuit or when the radio wave is in a high-frequency band such as 40 GHz or less, it is possible to prevent such unnecessary radio wave from leaking from the inside of the radar apparatus.

In the radar apparatus of the present invention, the shielding plate is provided in parallel to the radar, so that it is possible to shorten a distance from the radar to the shielding plate, shorten a dimension in the direction, and reduce a size of the radar apparatus.

In the radar apparatus of the present invention, since the shielding plate is provided in the predetermined position to be inclined at the predetermined angle, a part of radio wave reflected on the shielding plate travels in a direction in which the radio wave are not received by the radar. In other words, by directing a traveling direction of the reflected wave to the outside of the radar, and at the same time, giving an angle of incidence to the radar, it is possible to substantially attenuate electric power (unnecessary power amount of reflected wave described later) of the reflected wave received in the radar. Consequently, it is possible to efficiently prevent radio wave generated from the signal processing circuit from being radiated to the outside of the apparatus, without affecting transmission and reception of original radio wave.

In the radar apparatus of the present invention, the shielding plate is provided to satisfy the relation (the threshold of the radar)>Ps×s(1-y sin 2θ/h), so that it is possible to optimally set a relation between the shielding plate and the radar, taking the threshold into account.

In the radar apparatus of the present invention, the shielding plate is provided to satisfy the relation s²Ps>(the threshold of the radar)>Ps×s(1-y sin 2θ/h), so that it is possible to optimally set a relation between the shielding plate and the radar, taking into account the opening ratio of the opening of the shielding plate and the threshold.

In the radar apparatus of the present invention, a maximum dimension of the unit openings is a maximum dimension of projected images of the unit openings in the case that the unit openings are projected on a plane parallel to the radar, so that it is possible to form the unit openings as appropriate unit openings that satisfy the expression described above. In the radar apparatus of the present invention, an opening ratio of the opening of the shielding plate is an opening ratio of a projected image of the opening in the case that the opening is projected on a plane parallel to the radar, so that it is possible to set the opening ratio to an appropriate opening ratio that satisfies the expression described above.

In the radar apparatus of the present invention, the shielding plate is provided in a predetermined position and bent to be line symmetrical in the center thereof, so that it is possible to further reduce an angle of the inclination of the shielding plate with respect to the radar, shorten a distance from the radar to the shielding plate, and shorten a dimension in a direction from the radar to the shielding plate of the radar apparatus, and a size of the radar apparatus can be reduced. Moreover, the bent shielding plate is provided in a position closer to the radar, so that it is possible to shorten a distance from the radar to the shielding plate, and shorten a dimension in a direction from the radar to the shielding plate of the radar apparatus, and a size of the radar apparatus can be reduced.

The radar apparatus of the present invention further includes the radio wave absorbent, so that it is possible to absorb, at the shielding plate, radio wave (which would have been) reflected by the shielding plate (radio wave (which would be) received as noise). Moreover, it is possible to absorb, with the radio wave absorbent, radio wave transmitted from the radar and reflected by the shielding plate.

The radar apparatus of the present invention further includes the material layer that causes a path difference in radio wave reflected on the shielding plate, so that it is possible to attenuate the radio wave according to mutual interference of the radio wave caused by the path difference. Moreover, it is possible to attenuate, with the material layer that causes a path difference, radio wave transmitted from the radar and reflected by the shielding plate (radio wave received as noise) according to interference.

In the radar apparatus of the present invention, the cut pieces formed by punching out the shielding plate are bent to form the plurality of unit openings, so that it is possible to further reduce unnecessary radio wave made incident on the radar. Moreover, the cut pieces are bent such that radio wave are reflected in a direction farther away from the radar, so that it is possible to further reduce unnecessary radio wave made incident on the radar.

### BRIEF DESCRIPTION OF THE DRAWINGS

FIG. 1 is a diagram showing a structure of a radar apparatus of the present invention, especially FIG. 1A shows an example of the radar apparatus of the present invention and FIG. 1B shows another example of the radar apparatus of the present invention.

FIG. 2 is a perspective view showing the structure of the radar apparatus in FIG. 1.

FIG. 3 is a side view showing the structure of the radar apparatus in FIG. 1.

FIG. 4A and 4B are diagrams showing a structure of a shielding plate and an electric opening.

FIG. 5 is a diagram showing still another example of the structure of the radar apparatus of the present invention.

FIG. 6 is a diagram showing the structure of the radar apparatus in FIG. 5.

FIG. 7 is a diagram showing the structure of the radar apparatus in FIG. 5.

FIG. 8 is a diagram showing the structure of the radar apparatus in FIG. 5.

FIG. 9 is a diagram showing the structure of the radar apparatus in FIG. 5.

FIG. 10 is a diagram showing still another example of the structure of the radar apparatus of the present invention.

FIG. 11A and 11B are diagrams showing still another example of the structure of the radar apparatus of the present invention.

### DETAILED DESCRIPTION OF THE PREFERRED EMBODIMENTS

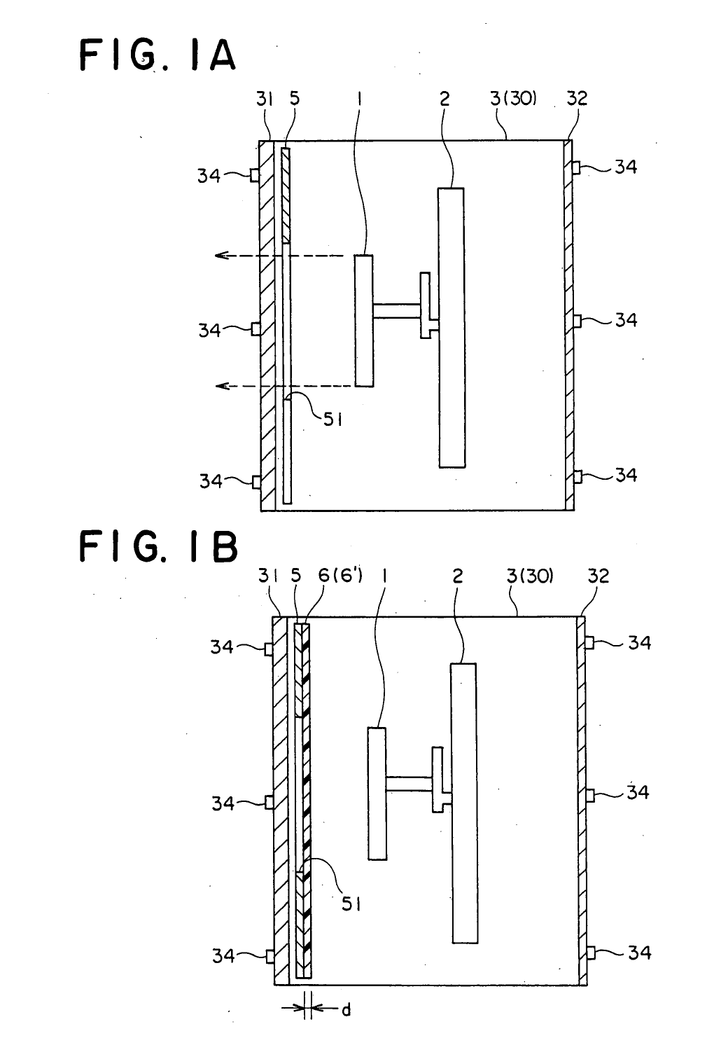

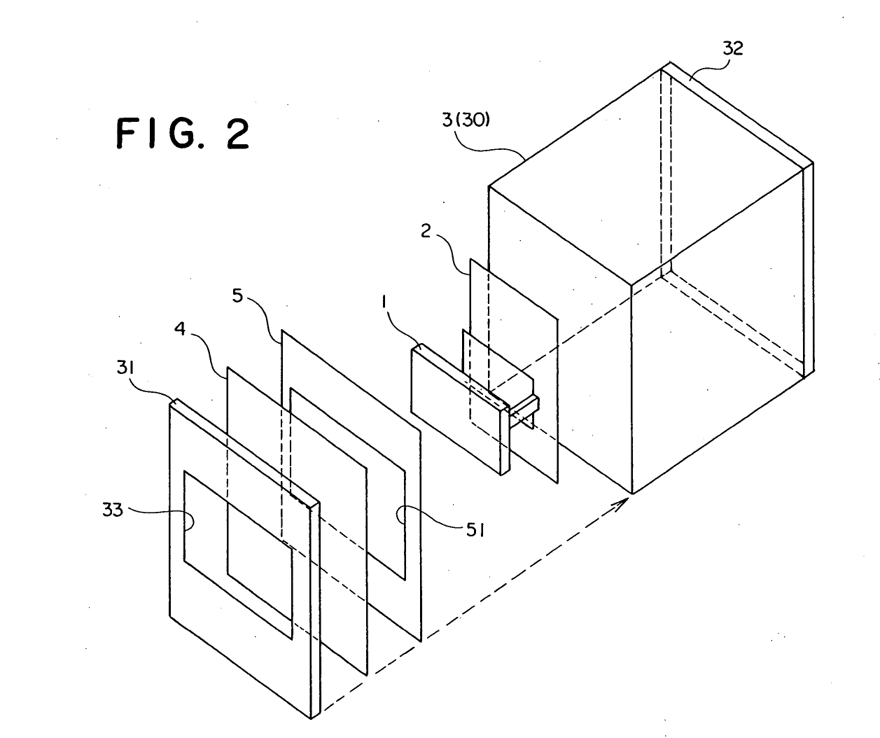

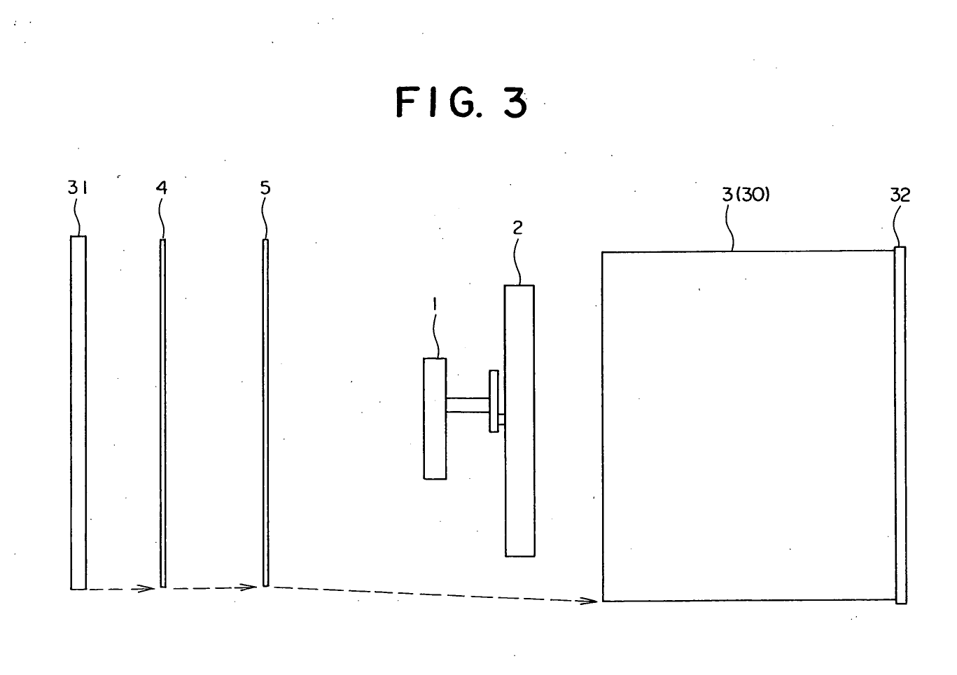

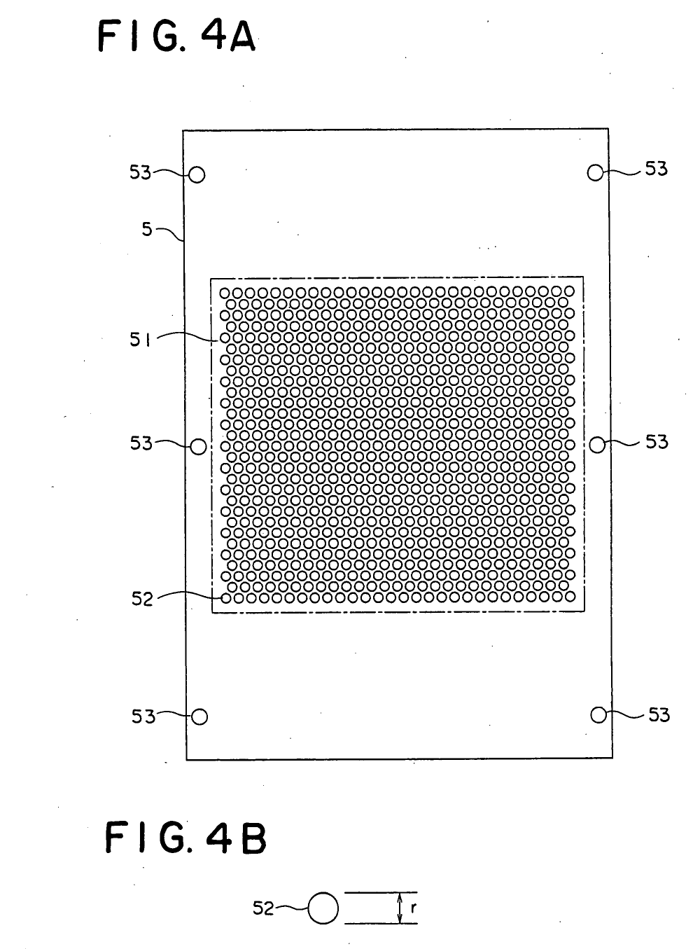

FIGS. 1A, 2, and 3 are diagrams of a radar apparatus, and show an example of a structure of a radar apparatus of the present invention. FIG. 1A shows a schematic structure of a partial section of the radar apparatus of the present invention. FIG. 2 shows a disassembled perspective view of the radar apparatus of the present invention. FIG. 3 shows a disassembled side view of the radar apparatus of the present invention. FIG. 4 is a diagram showing a structure of a shielding plate.

The radar apparatus of the present invention includes, as shown in FIGS. 1 to 4, a radar 1 employing millimeter wave, a signal processing circuit board 2, a housing 3, a radome (a protection plate or a cover) 4, and a shielding plate (a radio wave shielding plate) 5. The radar apparatus of the present invention is used as an object (or obstacle) sensor, for example.

The radar apparatus (the obstacle sensor) in this example transmits millimeter wave from the radar 1 to a reflector (a reflection plate) provided in an obstacle as a detection object provided at several tens meters ahead, receives the millimeter wave reflected on the reflector with the radar 1, and measures a time difference between the transmission and the reception. For example, when an obstacle appears between the reflector and the radar 1, the millimeter wave are reflected on the obstacle, so that a time difference between a transmission wave and a reception wave changes. It is possible to detect presence (and a position) of the obstacle using the change in the time difference. In this detection, in order to remove unnecessary reflected wave and noise, a threshold for detection processing is set, and misdetection of the obstacle is prevented.

The radar 1 includes a transmitter and a receiver having well-known structures, transmits radio wave (electromagnetic wave) at a predetermined frequency, and receives reflected wave of the radio wave. In this example, the radar 1 transmits radio wave (transmission wave) at a frequency of 76 GHz often used in obstacle sensors, and receives radio wave (reception wave), which is the radio wave reflected on the obstacle and returning to the radar 1. In other words, the radar 1 is a millimeter wave radar. The radio wave received by the radar 1 are sent to the signal processing circuit, and processed.

The signal processing circuit board 2 is mounted with a well-known signal processing circuit (not shown) for the millimeter wave radar 1. The signal processing-circuit controls transmission and reception of radio wave by the radar 1, and performs a detection processing of the radio wave received by the radar 1 using a predetermined threshold (a threshold of the radar 1). A reception wave having a power amount smaller than the threshold is neglected as noise, and a reception wave having a power amount larger than the threshold is extracted and processed as a detection signal of the obstacle. The threshold is determined according to the present invention as described later.

The signal processing circuit acts a source of generation of radio wave that should be shielded. When an operating frequency of the signal processing circuit is in a several tens MHz band, a high-order harmonics is about 1 GHz at the most, so that no problem is caused. However, in general, an operating frequency of the signal processing circuit tends to increase. When the operating frequency is in a several hundreds MHz band, a high-order harmonics is in a several GHz band. In this case, unnecessary radio wave which is generated from the signal processing circuit is radiated to the outside of the radar apparatus from an electric opening 33, when the electric opening 33 is covered by only the radome 4 described later.

The housing 3 has an external shape of a rectangular parallelepiped, and made of a material that reflects radio wave, i.e., a conductive material, for example, metal (a rigid body) such as aluminum or stainless steel. Actually, the housing 3 includes, as shown in FIG. 2, a main body 30 thereof and a front plate 31 and a rear plate 32, both of which are separable from the main body 30. As shown in FIG. 1, the front plate 31 is screwed to the main body 30 by screws 34 together with the radome 4 and the shielding plate 5. The rear plate 32 is also screwed to the main body 30. As shown in FIG. 2, the radar 1 is attached to (or mounted on) the signal processing circuit board 2. The signal processing circuit board 2 is attached to the center of the main body 30 of the housing 3 by an attaching means, which is not-shown.

The housing 3 has the electric opening 33 in a position corresponding to (the front) of the radar 1 in one surface (or the front plate 31) of the rectangular parallelepiped, in order to transmit radio wave from the radar 1 to the outside of the housing 3. The electric opening 33 is provided in a part (the center) of the front plate 31. The housing 3 is provided with the radar 1 and the signal processing circuit board 2 inside of it in a state that the radar 1 is opposed to the electric opening 33. The electric opening 33 only has to be transparent to radio wave from the radar 1, or allow the radio wave to be transmitted within a range of an allowable attenuation amount. The position corresponding to the radar 1 is, for example, an area formed on a plane of the front plate 31 (or the shielding plate 5, etc.) by radio wave from the radar 1, which travels in parallel to one another.

The housing 3 includes the radome 4 of a plane shape (for example, a rectangular shape) that covers (or closes) the electric opening 33, in order to prevent dust and the like from entering the inside of the radar apparatus, for example. The radome 4 is made of polycarbonate or the like, and is transparent to radio wave from the radar 1. The radome 4 is provided in a position right opposed to the front of the radar 1. However, actually, the radome 4 is attached to the front plate 31 of the housing 3 from the inside thereof. Therefore, in FIG. 1A, the radome 4 is hidden behind the front plate 31, its side of which is only shown, and invisible (the same applies in the following). Due to the same reason, in FIG. 1A, the electric opening 33 of the front plate 31 is not seen either. However, as described later, it may be considered that the electric opening 33 has the same size as an opening 51 of the shielding plate 5 (the same applies in the following).

The shielding plate 5 has a planar (for example, rectangular) external shape of a predetermined thickness (and is made of a rigid body), and is made of a material that reflects radio wave, i.e., a conductive material, for example, metal such as aluminum or stainless steel. In this example, as shown in FIG. 1, the shielding plate 5 is arranged in a position right opposed to the front of the radar 1, and in parallel to the radar 1 (perpendicularly to the bottom of the housing 3). As a result, as shown in FIGS. 2 and 3, the radar 1 (or a transmission and reception surface thereof, the shielding plate 5, the radome 4, and the front plate 31 (the electric opening 33) of the housing 3 are parallel to one another. Actually, the radar 1 is assembled as shown in FIG. 1A while this parallel state is kept.

The shielding plate 5 is provided on an inner side (the radar 1 side) of the radome 4. The shielding plate 5 is provided in a position right opposed to the front of the radar 1. However, actually, the shielding plate 5 is attached to the front plate 31 of the housing 3 from the inside thereof (via the radome 4). Therefore, actually, the shielding plate 5 is hidden behind the front plate 31, its side of which is only shown, and invisible in FIG. 1A. However, for convenience of explanation, the shielding plate 5 is shown by shifting the position (the same applies in FIGS. 1B, 5, and 10). The shielding plate 5 may be provided on an outer side (the front plate 31 side) of the radome 4.

The shielding plate 5 is provided between the radar 1 and the electric opening 33 of the housing 3. As shown in FIG. 4A, the shielding plate 5 has the opening 51 including a plurality of unit openings provided in a position corresponding to the radar 1. Therefore, the appropriate opening 51 is provided in the shielding plate 5 according to the present invention, so that the shielding plate 5 reflects (shields) radio wave that should not be radiated to the outside of the radar apparatus (hereinafter referred to as interference radio wave). However, the shielding plate 5 transmits original radio wave (millimeter wave) from the radar 1 (and attenuates the radio wave to some extent). Therefore, as shown in FIG. 4A, the shielding plate 5 has a structure including the opening 51 in which the plurality of unit openings 52 are regularly arranged in, for example, a matrix shape rather than a single opening. Consequently, characteristics of the shielding plate 5 are controlled double according to a size (a maximum dimension) “r” of the unit opening 52 shown in FIG. 4B and an opening ratio “s” of the opening 51.

As indicated by a dotted line in (only) FIG. 1A, radio wave transmitted by the radar 1 basically travels straight in parallel to a direction perpendicular to a transmission surface thereof. However, actually, the radio wave has a slight spread. Therefore, actually, as shown in FIGS. 1A and 4A, both of the electric opening 33 of the housing 3 and the opening 51 of the shielding plate 5 are adapted to have sufficiently larger regions (or areas than that in a position corresponding to the radar 1. For example, the electric opening 33 and the opening 51 are formed in identical shapes.

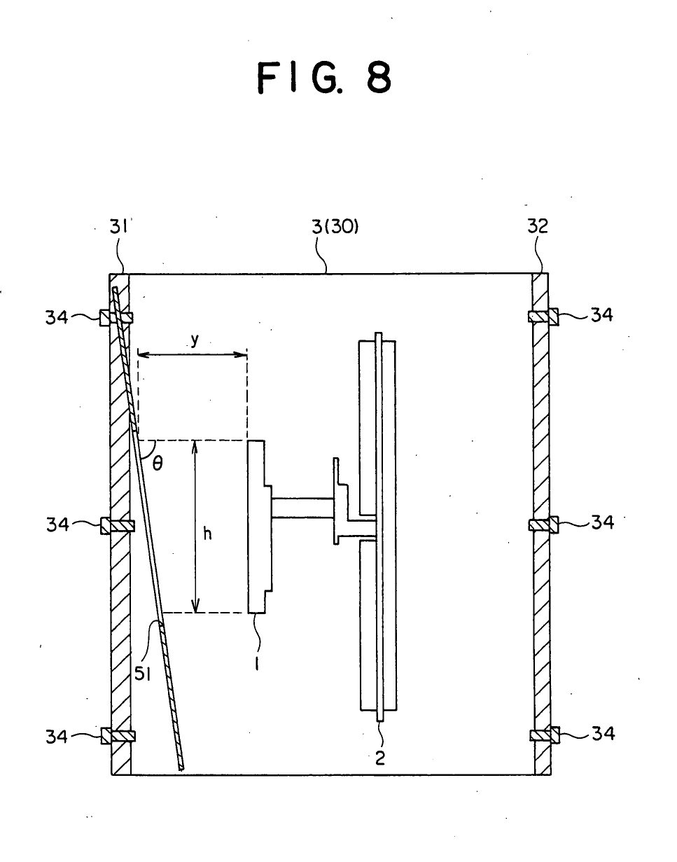

As shown in FIG. 4A, six screw holes 53 in total are provided at four corners and in the centers of long sides of the shielding plate 5. The screws 34 for attaching the front plate 31 of the housing 3 to the main body 30 penetrate through the screw holes 53, so that the shielding plate 5 is screwed to the main body 30 as described above. A state in which the screws 34 penetrate through the screw hole 53 is shown in only FIG. 8, and is not shown in FIGS. 1, 5, and 10. The radome 4 is screwed in the same manner.

In the shielding plate 5, as shown in FIG. 4, the unit openings 52 are set to satisfy a relation (half-wave length of radio wave that should be shielded)>(maximum dimension “r” (mm) of the unit opening 52)>(half-wave length of radio wave transmitted by the radar 1). As described above, the radio wave that should be shielded is, in this example, high-order harmonics of an operating frequency of the signal processing circuit, in particular, fifth harmonics, or radio waves of a frequency equal to or lower than 40 GHz. As described above, radio wave transmitted by the radar 1 (transmission wave) is, in this example, radio wave at a frequency of 76 GHz.

Therefore, in this case, when the maximum dimension of the unit opening 52 is “r”, the unit opening 52 is set to satisfy a relation 3.75 mm>maximum dimension “r” of the unit opening 52>2 mm. A shape of the unit opening 52 may be any one of a circular, a square, a rectangular, and a polygon such as a hexagon. When the unit opening 52 is circular, the maximum dimension “r” is a diameter of the unit opening 52 (see FIG. 4B). When the unit opening 52 is polygonal, the maximum dimension “r” is a longest diagonal line of the unit opening 52.

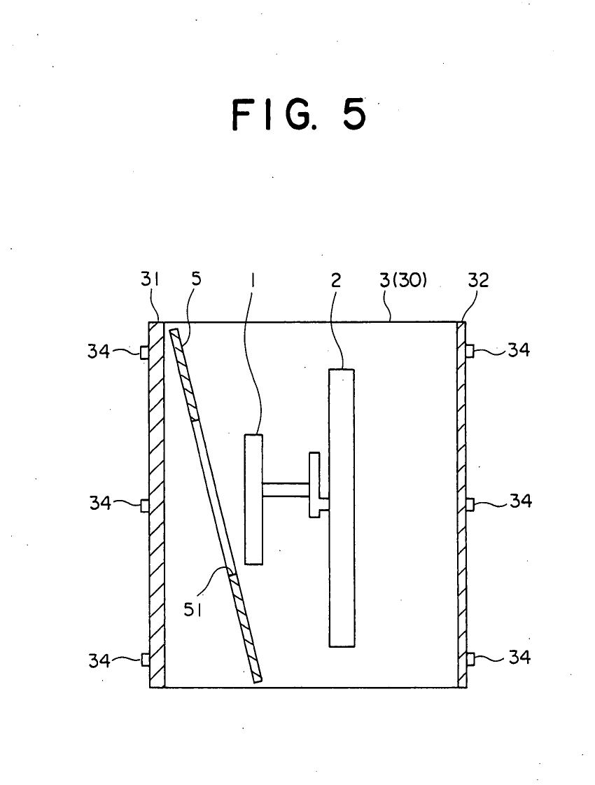

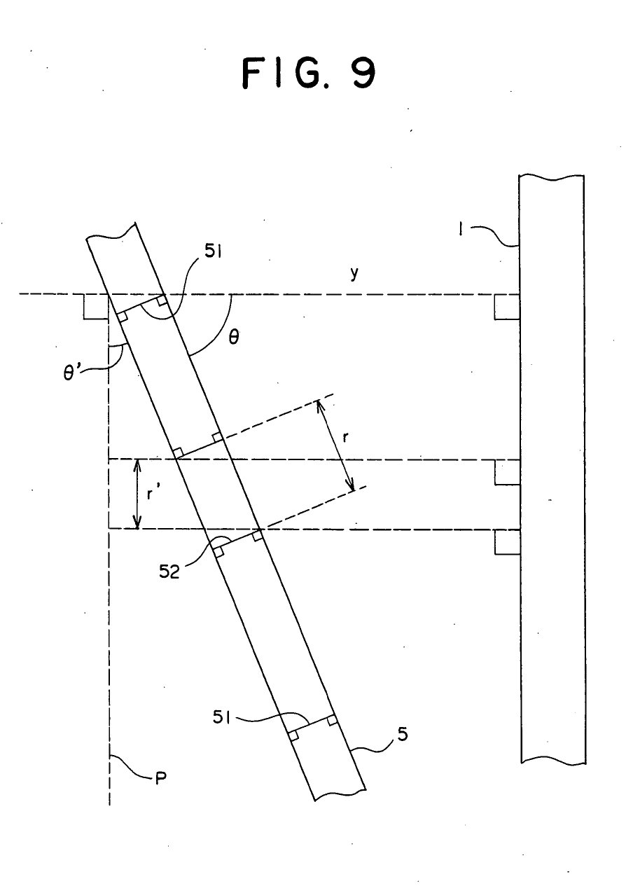

As it is seen from FIG. 9, in the case of this example, the unit opening 52 is formed perpendicularly to the front surface and the rear surface of the shielding plate 5 and parallel to a traveling direction of radio wave from the radar 1. Therefore, the maximum dimension “r” of the unit opening 52 formed becomes a maximum dimension as it is. As described later with reference to FIG. 9, regardless of whether the unit opening 52 is formed by a honeycomb structure, metal punching, and the like, the unit opening 52 is usually formed perpendicularly to the front surface and the rear surface of the shielding plate 5. In addition, in this example, the unit opening 52 is formed parallel to the traveling direction of the radio wave from the radar 1. However, in the case of an example in FIG. 5, the unit opening 52 is formed obliquely to the traveling direction.

For example, conforming to the regulation of FCC, as described above, a frequency of radio waves, which should be shielded, outputted from the signal processing circuit board 2 is equal to or lower than 40 GHz, and a half-wave length of the radio waves is equal to or larger than λ/2=3.75 mm. Therefore, radio wave at a frequency equal to or lower than 40 GHz are larger than the maximum dimension “r”, so that the radio wave cannot pass and propagate through the unit opening 52. In other words, it is possible to shield the radio wave of the frequency equal to or lower than 40 GHz. On the other hand, a frequency of the transmission wave (millimeter wave) of the radar 1 is 76 GHz, and a half-wave length of the transmission wave is λ/2=2 mm. Therefore, the transmission wave of the radar 1 is smaller than the maximum dimension “r” of the unit opening 52, so that the transmission wave can pass and propagate through the unit opening 52.

In the shielding plate 5, the opening ratio “s” (%) of the opening 51 is set to satisfy a relation ((power amount of the transmission wave of the radar 1)−(attenuated power amount of the transmission wave of the radar 1))>(threshold of the radar 1)>(unnecessary power amount of reflected wave at the shielding plate 5). Reasons for this are as described below. The opening ratio “s” is a % (percentage) representation of (total of areas of the plurality of unit openings 52)/(area of the opening 51) in the region of the opening 1.

First, power amount of the transmission and reception will be considered. When a power amount of reception waves of the radar 1 is smaller than a threshold of signal detection in the signal processing circuit, it is impossible to detect a signal. The power amount of the reception waves is roughly equal to a difference between the power amount of the transmission wave and the attenuated power amount of the transmission wave. Therefore, a relation (power amount of the transmission wave)−(attenuated power amount of the transmission wave)>(threshold) has to be established. As the attenuated power amount of the transmission wave, it can be considered that mainly attenuation in two times on a forward path and a backward path in the shielding plate 5 is dominant. When the reflected wave on the shielding plate 5 is larger than a threshold of signal detection in the signal processing circuit, all the reflected waves on the shielding plate 5 are detected as reflection on the object, in addition to reflected waves on a target object (obstacle). Therefore, unless a relation (threshold)>(power amount of the reflected wave on the shielding plate 5) has to be set and the reflected waves are removed as noise, it is impossible to detect a correct signal.

A relation between the power amount of the transmission and reception and the opening ratio “s” will be considered. According to our study, the power amount of the transmission wave and reception wave decreases in proportion substantially to the opening ratio “s” before and behind the shielding plate 5, when the transmission wave and the reception wave pass and propagate through the shielding plate 5, respectively. The transmission wave of the radar 1 attenuates when the transmission wave passes and propagates through the shielding plate 5. After reflecting on a reflector of an obstacle, the transmission wave attenuates when the transmission wave passes and propagates through the shielding plate 5 again, and is received by the radar 1. When the power amount of the transmission wave is “Ps” (mW), the reception wave power amount is “Pr” (mW), and the opening ratio of the opening 51 of the shielding plate 5 is “s”(%), a relation of
Ps×s²≡Pr and s²≡Pr/Ps
is established. From the latter expression, it is seen that an “s²” represents a ratio of the power amount of the transmission wave and the reception wave power amount. Moreover, when the threshold is “a” (mW), the attenuated power amount of the transmission wave is “b” (mW), and the unnecessary power amount of the reflected wave (the power amount of the reflected wave) is “c” (mW), we get
b≡Ps−Pr≡Ps−s²Ps=(1−s²)Ps.
According to our study, a detectable condition of the obstacle has to be
Ps−b≡Pr>a>c.
Therefore, a condition
s²Ps>a>c
is established.

A relation between the opening ratio “s” and the threshold “a” will be examined based on these relational expressions as follows. It is seen that, when “s”>70%, it is desirable to set the threshold “a” as a≡Ps/2. In other words, when the opening ratio “s” is larger than 70%, it is desirable to set the threshold “a” to about ½ of the power amount of the transmission wave “Ps”. Similarly, it is seen that, when “s?>60%, it is desirable to set the threshold “a” as a≡Ps/3, and, when “s”>50%, it is desirable to set the threshold “a” as a≡Ps/4.

A relation between the opening ratio “s” and the unnecessary power amount of the reflected wave “c” will be examined as follows. It is seen that, when “s”≡70%, the unnecessary power amount of the reflected wave “c” has to be held down to c<Ps/2. In other words, when the opening ratio “s” is about 70%, the unnecessary power amount of the reflected wave “c” should be set to smaller than ½ of the power amount of the transmission wave “Ps”. Similarly, it is seen that, when “s?≡60%, the unnecessary power amount of the reflected wave “c” has to be held down to c<Ps/3, and, when “s”≡50%, the unnecessary power amount of the reflected wave “c” has to be held down to c<Ps/4.

Easiness of machining of the shielding plate 5 will be examined as follows. For example, when the opening ratio “s”≡70% an area around the unit openings 52 (an area in which the conductive material is present) is extremely small in the opening 51. In this case, the shielding plate 5 is, for example, a well-known honeycomb structure or the like. Consequently, it is possible to secure necessary strength of the shielding plate 5, while realizing the opening ratio “s”. Therefore, when “s”≡70%, machining is complicated and manufacturing cost increases. On the other hand, when “s”≡50%, it is possible to manufacture the shielding plate 5 with necessary strength according to normal machining for punching out a plate (e.g., a metal plate) of a conductive material as a material of the shielding plate 5 (metal punching). Therefore, machining (and assembly) is easy and manufacturing cost is held down.

As described above, according to the present invention, it is possible to decide a relation among the power amount of the transmission wave “Ps”, the opening ratio “s”, and the threshold “a”, and to decide a relation between the opening ratio “s” and the unnecessary power amount of the reflected wave “c”. It is possible to set the opening ratio “s” of the opening 51 in a state which satisfies a relation (power amount of the transmission wave Ps−attenuated power amount of the transmission wave b)≡Pr>threshold “a”>power amount of the reflected wave “c”. Moreover, by setting these to appropriate values, it is possible to suppress the attenuation amount of original radio wave while shielding interference radio wave. In this way, the present invention makes it possible to control the characteristics of the shielding plate 5 using the maximum dimension “r” of the unit opening 52 and the opening ratio “s”, to reflect (or shield) interference radio wave, and to suppress the attenuation amount of original radio wave. Thus, the present invention can detect and process accurately the reflected wave on an obstacle.

In order to operate the electronic apparatus employing radio wave in the millimeter wave band according to only a technical regulations conformity certificate (i.e., without any special certificate), a power amount of the transmission wave has to be a value as small as 10 mW (milliwatt) or less. Since the reception wave power amount “Pr” decreases due to the above regulation, it is desirable that the threshold “a” is also small. Therefore, according to the above examination, it is desirable that the unnecessary power amount of the reflected wave “c” is smaller. In this case, since the shielding plate 5 takes the honeycomb structure or the like, an increase in manufacturing cost is caused.

On the other hand, according to the present invention, although it is possible to prevent the power amount of the reflected wave by the shielding plate 5 from exceeding the threshold, as it is seen from the above examination, the unnecessary power amount of the reflected wave “c” has to be considerably small. However, actually, an influence of the reflected wave by the shielding plate 5 is considerably large (a value of the reflected wave is large). Therefore, detection of the obstacle has to be performed without being hindered by the reflected wave. Thus, it is desirable to reduce the unnecessary power amount of the reflected wave “c” with some means.

FIG. 1B is a diagram of a radar apparatus, and shows another example of the structure of the radar apparatus of the present invention. FIG. 1B corresponds to FIG. 1A. In this example, the unnecessary power amount of the reflected wave “c” is reduced by a radio wave absorbent 6, or a material layer 6′ that causes a path difference in radio wave. This example is the same as the example in FIGS. 1 to 4 except the radio wave absorbent 6 (and the material layer 6′).

As shown in FIG. 1B, the radar apparatus of this example includes the radio wave absorbent 6. In this example, the radio wave absorbent 6 is provided on a surface of the shielding plate 5, and the surface is opposed to the radar 1. The radio wave absorbent 6 only has to be provided at least at the opening 51 in the surface opposed to the radar 1. The radio wave absorbent 6 is made of a well-known radio wave absorbing material. The radio wave absorbent 6 is made of, for example, a material that absorbs radio wave transmitted from the radar 1 and reflected by the shielding plate 5 (radio wave received as noise). Consequently, it is possible to absorb the radio wave reflected by the shielding plate 5, and to reduce the unnecessary power amount of the reflected wave “c”. Therefore, it is possible to reduce the opening ratio “s”. As a result, it is possible to adopt the metal punching for machining of the shielding plate 5.

The radar apparatus may include, instead of the radio wave absorbent 6, the material layer 6′ that causes a path difference in the radio wave reflected at the shielding plate 5. The material layer 6′ that causes a path difference is provided at least at the opening 51 in the surface of the shielding plate 5, and the surface is opposed to the radar 1. A thickness “d” (see FIG. 1B) of the material layer 6′ that causes a path difference is set to, for example, ¼ of a wavelength λ of the radio wave transmitted from the radar 1. Consequently, it is possible to cause a path difference (or to shift a phase) equivalent to a half-wave length (λ/2) of the wavelength in the transmission wave reflected on the shielding plate 5, and to attenuate radio wave transmitted from the radar 1 and reflected by the shielding plate 5 (radio wave received as noise) by mutual interference. Therefore, it is possible to reduce the unnecessary power amount of the reflected wave “c”, and to reduce the opening ratio “s”. As a result, it is possible to adopt the metal punching for machining of the shielding plate 5.

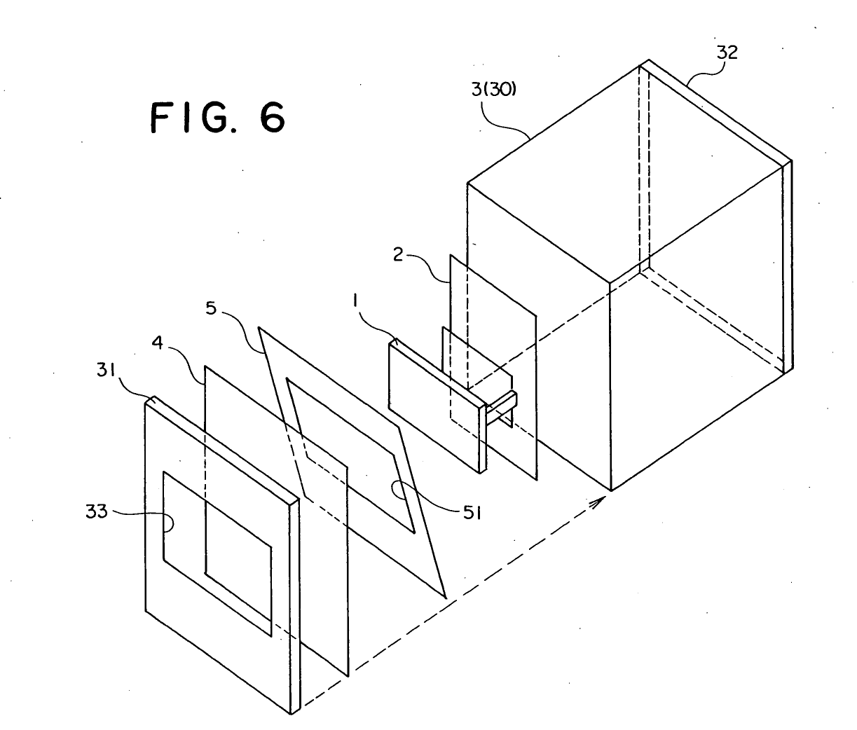

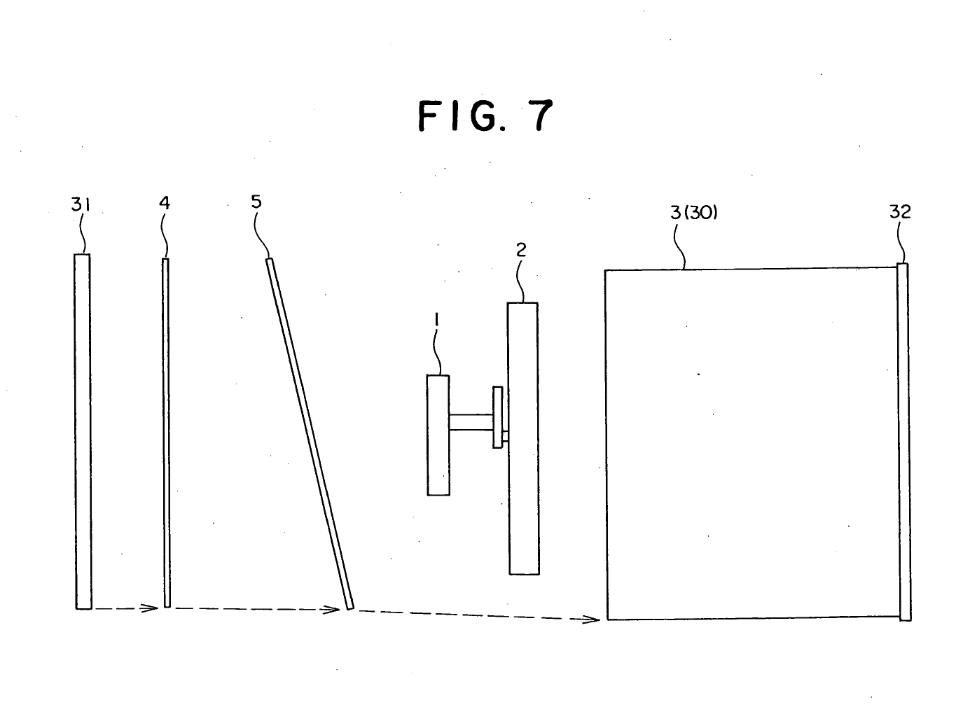

FIGS. 5 to 9 are diagrams of the radar apparatus, and show another example of the structure of the radar apparatus of the present invention. FIGS. 5, 6, and 7 corresponds to FIGS. 1A, 2, and 3, respectively. FIGS. 8 and 9 are explanatory diagrams showing an inclination of the shielding plate 5. In this example, the shielding plate 5 is inclined by an angle 6′ (see FIG. 9) with respect to the radar 1, so that the unnecessary power amount of the reflected wave “c” is reduced.

In the radar apparatus of this example, as shown in FIGS. 5 to 9, the shielding plate 5 is provided at a position “y” (mm) which is apart from the radar 1 by a predetermined distance, and is formed so as to incline by a predetermined angle 6′ with respect to the radar 1. This example is the same as the example in FIGS. 1 to 4 except the inclination of the shielding plate 5.

The position “y” and the angle θ′ of the shielding plate 5 are shown in FIGS. 8 and 9. The position (or distance) “y” is a longest path of the radio wave between (a transmission surface of) the radar 1 and the shielding plate 5. The angle θ′ is an angle formed by (the transmission surface of) the radar 1 and the shielding plate 5, or an angle formed by a direction in which radio wave are transmitted from the radar 1 and the shielding plate 5. A plane “P” is a surface parallel to (the transmission surface of) the radar 1, and is a projection surface assumed to project the shielding surface 5 as described later. As it is seen from FIG. 9, the angle θ is (90−θ′), and is an angle formed by the longest path and the shielding plate 5. As described above, the radio wave transmitted by the radar 1 travels straight in parallel to a direction perpendicular to the transmission surface of the radar 1 (FIG. 1A). Therefore, when the width (or the height) of the radar 1 is “h”, the position “y” is the length of a path of the radio wave at an upper end of the radar 1. The width “h” of the radar 1 may be considered the width of the transmission surface of the radar 1.

As shown in FIG. 5 to 9, the shielding plate 5 is provided to incline to the left side on the paper surface, but may incline to the opposite side. In other words, as opposed to FIGS. 5 to 9, the shielding plate 5 may be provided to incline to the right side on the paper surface.

In this example, the shielding plate 5 is inclined by the angle θ′ with respect to the radar 1. Consequently, a traveling direction of the reflected wave is directed to the outside of the radar 1, and, at the same time, an angle of incidence on the radar 1 is given, so that electric power of the reflected wave received at the radar 1 is attenuated on a large scale. In other words, it is possible to reduce a rate of incidence on the radar 1 after reflection on the shielding plate 5 of radio wave transmitted from the radar 1 and reflected by the shielding plate 5 (radio wave received as noise). Consequently, it is possible to reflect (or shield) interference radio wave using the maximum dimension “r” of the unit openings 52 and the opening ratio “s”, to suppress the attenuation amount of original radio wave, and, in addition, to suppress a rate of incidence on the radar 1 of the radio wave transmitted from the radar 1 and reflected on the shielding plate 5.

In the case of this example, even if a power amount of the transmission wave is equal to or smaller than 10 mW, it is possible to suppress a rate of radio wave transmitted from the radar 1 and reflected by the shielding plate 5 (radio wave received as noise), so that it is possible to set the threshold “a” of detection small (about Ps/4). Consequently, it is possible to reduce the opening ratio “s” (to about 50%), and adopt the shielding plate 5 manufactured by the metal punching with low machining cost.

A relation between the position “y” and angle θ and the threshold “a” will be examined based on the expressions described above as follows. When a power amount of the transmission wave is “Ps”, a distance between the radar 1 and the shielding plate 5 is “y”, an inclination of the shielding plate 5 with respect to the radar 1 is θ′, θ=(90−θ′), the width of the radar 1 is “h”, and attenuation amount of an unnecessary reflected wave (in the transmission wave, a power amount of radio wave reflected on the shielding plate 5 and deviating to the outside of the radar 1) is “d” (mW),
d≡Ps×s×y sin(π−2θ)/h=Ps×s×y sin 2θ/h.
is obtained. Thus, an unnecessary power amount of the reflected wave “c” (mW) is
c≡Ps×s−d, i.e., c≡Ps×s(1−y sin 2θ/h).
Therefore, θ and “y” only have to be adjusted such that the unnecessary power amount of the reflected wave “c” is smaller than the threshold. In other words, the shielding plate 5 is provided to satisfy a relation (threshold of the radar 1)>Ps×s(1−y sin 2θ/h). Consequently, it is possible to optimize a relation between the shielding plate 5 and the radar 1 taking into account the threshold of the radar 1.

A relation between the position “y” and angle θ and the opening ratio “s” and threshold “a” will be examined as follows based on the expression described above. When an opening ratio of the opening 51 is “s”, the shielding plate 5 is provided to satisfy a relation s²Ps>(threshold of the radar 1)>Ps×s(1−y sin 2θ/h). Consequently, it is possible to optimize a relation between the shielding plate 5 and the radar 1 taking into account the opening ratio “s” of the opening 51 of the shielding plate 5 and the threshold of the radar 1.

Specifically, in this example, the shielding plate 5 is set as described below. The shielding plate 5 includes the opening 51 having the opening ratio “s”, which satisfies a relation s²Ps>a>Ps×s(1−y sin 2θ/h), and is arranged with an inclination θ′ with respect to the radar 1. And, the opening 51 includes the plurality of unit openings 52, which satisfy a relation 3.75 mm>maximum dimension “r” of unit openings>2 mm. Moreover, the power amount of the transmission wave Ps is 8 mW, the opening ratio “s” is 50%, the width “h” of the radar 1 is 50 mm, and the threshold “a” is 1 mW. Under this condition, the inclination θ of the shielding plate 5 is set to 45 degrees, and the distance y between the radar 1 and the shielding plate 5 is set to 38 (mm) or more. Alternatively, the inclination θ of the shielding plate 5 has to be set to 60 degrees, and the distance “y” between the radar 1 and the shielding plate 5 has to be set to 44 (mm) or more. Consequently, the radar apparatus in this example secures transmission wave power from the radar 1 while realizing a relation Ps<10 mW, suppresses unnecessary reflected wave power to the threshold or less, and prevents interference radio wave from the signal processing circuit board 2 from being radiated to the outside.

Actually, in the case of this example, the following points are further taken into account. As shown in FIG. 9, when the shielding plate 5 is inclined with respect to the radar 1, the maximum dimension “r” of the unit opening 52 viewed from the radar 1 looks small (or looks r′). Thus, in this case, it is necessary to increase, taking into account the inclination of the shielding plate 5, the maximum dimension “r” by a dimension corresponding to the angle of the inclination.

In this example, the maximum dimension “r” of the unit opening 52 of the opening 51 of the shielding plate 5 is replaced by a maximum dimension “r′” of a projected image in the case that the unit opening 52 is projected on a plane “P” parallel to (the transmission surface) of the radar 1. In other words, the maximum dimension “r′” in the projected image is set to satisfy a relation (half-wave length of radio wave that should be shielded)>(maximum dimension “r” of the unit opening 52) and (maximum dimension “r′” of the projected image of the unit opening 52)>(half-wave length of radio wave transmitted by the radar 1). The maximum dimension “r” has to be increased to satisfy the above condition.

Moreover, in this example, the opening ratio “s” of the opening 51 of the shielding plate 5 is replaced by an opening ratio “s” of a projected image in the case that the opening 51 is projected on the plane “P” parallel to the radar 1. In other words, the opening ratio “s” of the projected image is set to satisfy the expression described above. The opening ratio “s” has to be set to satisfy the above condition.

The unit opening 52 may also be formed (machined) obliquely to (crossing at the angle θ or θ′) the front surface and the rear surface of the shielding plate 5, and formed parallel to the traveling direction of the radio wave from the radar 1. In this case, as it is also seen from FIG. 9, the maximum dimension “r” of the unit opening 52 formed is used as a maximum dimension as it is. Such a shielding plate 5 is obtained by calculating the angle θ in advance according to the present invention and machining the shielding plate 5 using the angle θ.

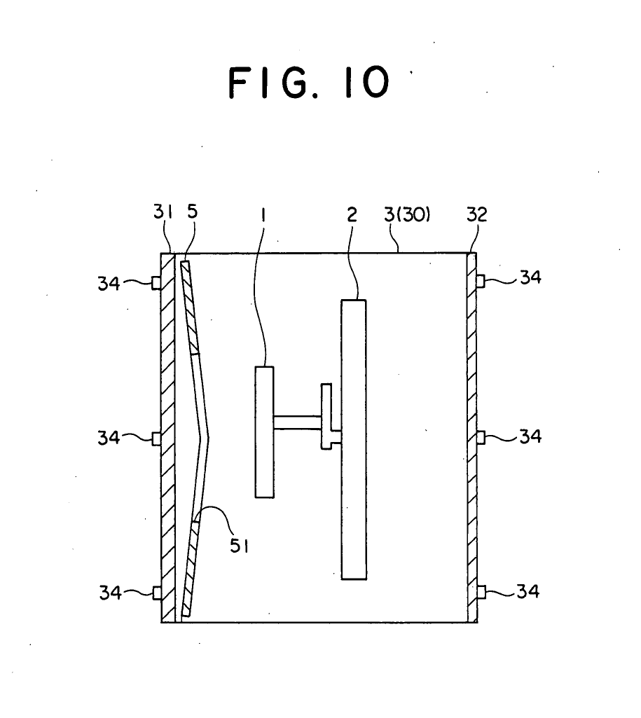

FIG. 10 is a diagram of a radar apparatus, and shows still another example of the structure of the radar apparatus of the present invention. FIG. 10 corresponds to FIG. 1A and FIG. 5.

In the radar apparatus of this example, as shown in FIG. 10, the shielding plate 5 is provided at a position which is apart from the radar 1 by a predetermined distance, and is bent to be line symmetrical in the center thereof. Consequently, it is possible to double an amount of radio wave reflected away from the radar 1. Thus, it is possible to reduce the distance from the radar 1 to the shielding plate 5, and to shorten a dimension in a direction from the radar 1 to the shielding plate 5 of the radar apparatus, so that a size of the radar apparatus can be reduced.

In this case, compared with the case that the shielding plate 5 is provided in the first position “y” apart from the radar 1 to be inclined at the first angle 6′ (see FIG. 9) with respect to the radar 1 without being bent, the bent shielding plate 5 is provided in a second position y′ (not shown) closer to the radar 1 than the first position “y” (see FIGS. 8 and 9) at the same first angle θ′. Consequently, it is possible to reduce the distance from the radar 1 to the shielding plate 5, and shorten a dimension in the direction from the radar 1 to the shielding plate 5 of the radar apparatus, so that a size of the radar apparatus is reduced.

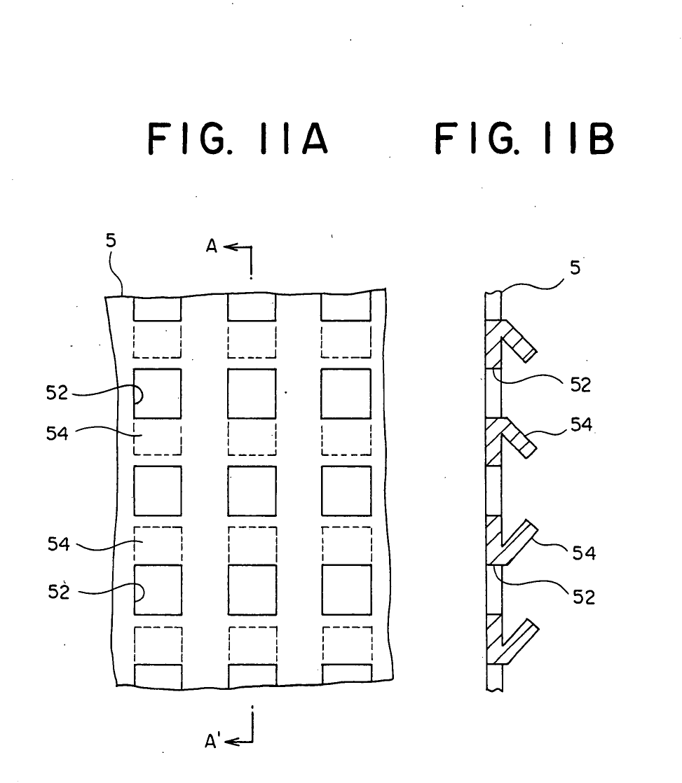

FIG. 11 is a diagram of a radar apparatus, and shows still another example of the structure of the radar apparatus of the present invention. FIG. 11 is shows a part of the shielding plate 5 shown in FIG. 4, FIG. 11A shows a structure of a plane of the shielding plate 5, and FIG. 11B shows a structure of a section along a cutting line A-A′ in FIG. 11A.

In the radar apparatus in this example, as shown in FIG. 11, cut pieces 54, which is formed by punching out the shielding plate 5 in order to form the plurality of unit openings 52 in the shielding plate 5, are bent to a side of a surface, which is opposed to the radar 1, of the shield plate 5, without being cut off from the shielding plate 5. In FIG. 11A, for convenience of illustration, the cut pieces 54 are indicated by dotted lines. In this case, a planar shape of the unit openings 52 is rectangular (or square), as shown in FIG. 11. Consequently, it is possible to further reduce unnecessary radio wave made incident on the radar 1.

Then, the cut pieces 54 are bent to reflect radio wave reflected on the shielding plate 5 in a direction farther away from the radar 1. As shown in FIG. 11B, in the upper half of the shielding plate 5, the cut pieces 54 are bent downward to reflect radio wave further upward, and reduce an amount of radio wave made incident on the radar 1. In the lower half of the shielding plate 5, the opposite of this is performed. Consequently, moreover, it is possible to further reduce unnecessary radio wave made incident on the radar 1.

The present invention has been explained in accordance with the embodiment thereof. However, various modifications of the present invention are possible within the scope of the gist of the present invention.

For example, means for attenuating unnecessary reflected wave may be combined in various ways. Specifically, the radio wave absorbent 6 or the material layer 6′ that causes a path difference in radio wave may be provided in the radar apparatus in FIG. 5 to 9 and the radar apparatus in FIG. 10, as shown in FIG. 1B. In the radar apparatus of FIGS. 1 to 4, in the radar apparatus of FIGS. 5 to 9, and in the radar apparatus of FIG. 10, the cut pieces 54 obtained by punching out the shielding plate 5 may be bent to the side of the surface, which is opposed to the radar 1, of the shielding plate 5 without cutting off the cut pieces 54 from the shielding plate 5, as shown in FIG. 11. In the case of the radar apparatus in FIG. 10, taking into account a direction of bending of the shielding plate 5, the cut pieces 54 are bent such that radio wave reflected on the shielding plate 5 is reflected in a direction farther away from the radar 1.

As explained above, according to the present invention, in the radar apparatus, the shielding plate, that includes the opening including the plurality of unit openings and having the predetermined opening ratio, is provided between the radar and the electric opening. Consequently, it is possible to prevent radio wave generated from the signal processing circuit from being radiated to the outside of the apparatus from the electric opening as unnecessary radio wave and reduce an influence of the radio wave on transmission, and to reception of original radio wave of the radar apparatus as much as possible. Therefore, with the simple structure of the shielding plate, it is possible to reduce radiation of unnecessary radio wave from the electric opening, and to reduce EMI of the radar apparatus. In addition, it is possible to accurately set a distance from the radar to the shielding plate, so that it is possible to shorten a dimension in a direction from the radar to the shielding plate of the radar apparatus, and to reduce a size of the radar apparatus.

According to the present invention, in the radar apparatus, by inclining the shielding plate by the predetermined angle, it is possible to efficiently suppress reflective wave on the shielding plate, which are not original reception wave. In addition, it is possible to appropriately set a threshold of the radar, an opening ratio of the opening of the shielding plate, and an inclination and a distance of the shielding plate. Moreover, in this case, a maximum dimension of the unit openings and an opening ratio of the opening of the shielding plate are accurately set base on a projected image, so that it is possible to shorten a dimension in a direction from the radar to the shielding plate of the radar apparatus, and to reduce a size of the radar apparatus.

According to the present invention, in the radar apparatus, by bending the shielding plate to be line symmetrical in the center thereof, it is possible to more efficiently suppress the reflected wave on the shielding plate, which are not original reception wave. Consequently, it is possible to shorten a distance from the radar to the shielding plate, and to shorten a dimension in a direction from the radar to the shielding plate of the radar apparatus, so that a size of the radar apparatus can be reduced.

The radar apparatus of the present invention further includes the radio wave absorbent or the material layer that causes a path difference in radio wave. Thus, it is possible to absorb or attenuate, in the shielding plate, the reflected wave on the shielding plate, which are not original reception wave, and to decrease an influence of the reflected wave on the shielding plate, which are not original reception wave.

According to the present invention, in the radar apparatus, the cut pieces are bent which are obtained by punching out the shielding plate to form the unit openings. Thus, it is possible to decrease an influence of reflection of radio wave from the signal processing circuit on the shielding plate.

What is claimed is:

1. A radar apparatus comprising:
a radar transmitting and receiving radio wave of a predetermined frequency;
a signal processing circuit board mounted with a signal processing circuit which controls the transmission and reception of the radio wave by the radar and performs detection processing of the radio wave received by the radar using a predetermined threshold;
a housing having an electric opening in a position corresponding to the radar, and being provided with the radar and the signal processing circuit board inside of the housing in a state that the radar is opposed to the electric opening; and
a shielding plate made of a planar conductive material, provided between the radar and the electric opening of the housing, and having an opening which comprises a plurality of unit openings in a position corresponding to the radar,
wherein the unit openings satisfy a relation (half-wave length of radio wave which should be shielded)>(maximum dimension of the unit openings)>(half-wave length of radio wave transmitted by the radar), and
wherein an opening ratio of the opening is set to satisfy a relation ((power amount of the transmission wave of the radar)−(attenuated power amount of transmission wave of the radar))>(the threshold of the radar)>(power amount of reflected wave at the shielding plate).

2. The radar apparatus according to claim 1, wherein the radio wave which should be shielded is high-order harmonics at an operation frequency of the signal processing circuit.

3. The radar apparatus according to claim 1, wherein the shielding plate is provided in a position which is apart from the radar by a predetermined distance, and is formed in parallel to the radar.

4. The radar apparatus according to claim 1, wherein the shielding plate is provided in a position which is apart from the radar by a predetermined distance, and is formed so as to incline by a predetermined angle with respect to the radar.

5. The radar apparatus according to claim 4, wherein the shielding plate is provided to satisfy a relation (the threshold of the radar)>Ps×s(1−y sin 2θ/h), where an opening ratio of the opening is s, power amount of the transmission wave is Ps, a distance between the radar and the shielding plate is y, an inclination of the shielding plate with respect to the radar is θ, and width of the radar is h.

6. The radar apparatus according to claim 5, wherein the shielding plate is provided to satisfy a relation s²Ps>(the threshold of the radar)>Ps×s(1−y sin 2θ/h).

7. The radar apparatus according to claim 6, wherein a maximum dimension of the unit openings of the opening of the shielding plate is a maximum dimension of projected images of the unit openings in the case that the unit openings are projected on a plane parallel to the radar.

8. The radar apparatus according to claim 6, wherein an opening ratio of the opening of the shielding plate is an opening ratio of a projected image of the opening in the case that the opening is projected on a plane parallel to the radar.

9. The radar apparatus according to claim 1, wherein the shielding plate is provided in a position which is apart from the radar by a predetermined distance, and is bent to be line symmetrical in the center thereof.

10. The radar apparatus according to claim 9, wherein, when compared with a case that the shielding plate is provided in a first position apart from the radar to be inclined by a first angle with respect to the radar without being bent, the bent shielding plate is provided in a second position closer to the radar than the first position at the first angle.

11. The radar apparatus according to claim 1, further comprising:
a radio wave absorbent provided at least at the opening in a surface of the shielding plate, and the surface is opposed to the radar.

12. The radar apparatus according to claim 11, wherein the radio wave absorbent absorbs radio wave transmitted from the radar and reflected by the shielding plate.

13. The radar apparatus according to claim 1, further comprising:
a material layer provided at least at the opening in a surface of the shielding plate, and causing a path difference in radio wave reflected on the shielding plate, the surface being opposed to the radar.

14. The radar apparatus according to claim 13, wherein the material layer causing the path difference is set to thickness ¼ of a wavelength of radio wave transmitted from the radar.

15. The radar apparatus according to claim 1, wherein cut pieces formed by punching out the shielding plate to form the plurality of unit openings in the shielding plate are bent to a side of a surface of the shielding plate without being cut off from the shielding plate, and the surface is opposed to the radar.

16. The radar apparatus according to claim 15, wherein the cut pieces are bend to reflect radio wave reflected on the shielding plate in a direction away from the radar.
